(19) United States
(12) Patent Application Publication
(10) Pub. No.: US 2015/0354250 A1
(43) Pub. Date: Dec. 10, 2015

(54) MOTOR VEHICLE DOOR LOCK

(71) Applicant: KIEKERT AKTIENGESELLSCHAFT, Heiligenhaus, North Rhine-Westphalia (DE)

(72) Inventors: Thorsten Bendel, Oberhausen, North Rhine-Westphalia (DE); Armin Handke, Duisburg, North Rhine-Westphalia (DE); Carsten Fuchs, Dusseldorf, North Rhine-Westphalia (DE); Matthias Ochtrop, Dorsten, North Rhine-Westphalia (DE); Dirk Eichel, Velbert, North Rhine-Westphalia (DE); Omer Inan, Dorsten, North Rhine-Westphalia (DE); Jan Faitl, Prelouc, Pardubice Region (CZ); Tomas Janacek, Pardubice, Pardubice Region (CZ)

(21) Appl. No.: 14/654,623

(22) PCT Filed: Dec. 18, 2013
(86) PCT No.: PCT/DE2013/000800

§ 371 Date: Jul. 17, 2015

(30) Foreign Application Priority Data
Dec. 21, 2012 (DE) 10 2012 025 448.2

(51) Int. Cl. E05B 77/04; E05B 79/10

(52) U.S. Cl. CPC E05B 77/04; E05B 79/10

(57) ABSTRACT

The invention relates to a motor vehicle door lock, which is equipped with a ratchet mechanism, a tripping lever for opening the ratchet mechanism and a ratchet lever that is pivotable about an axis. The ratchet lever renders the ratchet mechanism ineffective, at least with regard to the magnitude and direction of occurring retarding forces, for example in an accident (“in the event of a crash”) ineffective. According to the invention the ratchet lever is connected to an actuating lever applying force to a tripping lever in such an articulated manner that both levers together in the normal operation describe a predetermined normal actuation track (R1) without mechanical blocking and in the crash operation describe a crash actuation track (R2) deviating from the normal actuation track (R1) while simultaneously a mechanical blocking occurs.

### CROSS-REFERENCE TO RELATED APPLICATIONS

This application is the U.S. national stage application of International Patent Application No. PCT/DE2013/000800, filed Dec. 18, 2013, which claims priority of German Application No. 10 2012 025 448.2, filed Dec. 21, 2012, which are both hereby incorporated by reference.

### BACKGROUND

The invention relates to a motor vehicle door latch, which is equipped with a locking mechanism, a tripping lever for opening the locking mechanism and a ratchet lever that is pivotable around an axis, rendering the locking mechanism ineffective at least with regard to the magnitude and direction of occurring retarding forces, for example in an accident (“crash”).

In a motor vehicle door latch of the described design, as disclosed, for instance in DE 10 2011 010 816 A1 of the applicant, the ratchet lever is in a blocking position in relation to the locking mechanism during normal operation. In the event of a crash, the ratchet lever blocks the locking mechanism and only releases it for normal operation. The ratchet lever is elastically connected to the tripping lever by means of at least one spring. As soon as the tripping lever is pivoted for opening the locking mechanism, the pivoting movement ensures that the blocking lever is acted upon by the spring. In this way, the ratchet lever is also moved in normal operation, increasing overall reliability whilst providing a simple design.

As usual, the ratchet lever or the mass latch provided at this point ensures that the considerable acceleration forces generated in the event of an accident or a “crash” do not cause unintentional opening of the locking mechanism and thus of the associated door latch or also of the motor vehicle door. Instead, the tripping lever is not acted upon when abnormal acceleration forces are exerted in the event of a crash. This can be achieved by the fact that an actuating lever mechanism, generally acting on the tripping lever in normal operation, is blocked.

A similar approach is used in the generic state of the art disclosed in EP 1 375 794 A2. This patent discloses a ratchet lever that in the event of a crash interrupts a continuous mechanical connection of the associated actuating lever mechanism up to the tripping lever of the locking mechanism. For this purpose, the ratchet lever acts on an actuating lever of the actuating lever mechanism in order to pivot it.

Previous methods have generally proved to be successful as regards functionality and reliability. However, the ratchet lever in DE 10 2011 010 816 A1 and in the respective EP 1 375 794 A2 are connected to a frame box separately from the locking mechanism and also the actuating lever mechanism. This results in a position of the axis of the ratchet lever that is typically defined by a bearing bolt, having a more or less distinct distance from the actuating lever mechanism and also from the locking mechanism. As a result, the design of the known motor vehicle door latches and of the ratchet lever is relatively generous. This contradicts the trend for more and more compact designs. The invention aims to remedy this.

### SUMMARY

The invention is based on the technical problem of further developing said motor vehicle door latch in such a way that whilst maintaining the full functionality, a particularly compact and low-cost embodiment is provided.

In order to solve this technical problem, a generic motor vehicle door latch of the invention is characterized by the ratchet lever being flexibly connected to the actuating lever acting upon the tripping lever in such a way that the two levers together follow a specified normal actuation track during normal operation, without mechanical blocking and follow, in the event of a crash, a crash actuation track deviating from the normal actuation track with simultaneous blocking.

According to the invention, the ratchet lever is thus first of all and in contrast to prior art, mounted on an actuating lever. This means that the ratchet lever is flexibly connected to the actuating lever and is not pivotably mounted in a frame box in contrast to, for instance, the teaching of DE 10 2011 010 816 A1. This already produces a particularly compact result, as no separate bearing point is required in the frame box. Also, the flexible mounting of the ratchet lever on the actuating lever offers the option of locating the ratchet lever above other elements of the motor vehicle door latch when viewed from the top. As a result, a particularly compact design can be achieved.

In order to ensure the desired correct functionality, the ratchet lever and the actuating lever, acting on the tripping lever, move along the normal actuation track during normal operation. No mechanical blocking occurs. In contrast, the crash operation corresponds to a crash actuation track, deviating from the normal actuation track jointly covered by the two levers. This crash actuation track also contains a mechanical blocking.

The mechanical blocking ensures that the tripping lever acting on the actuating lever does not even reach the tripping lever or cannot mechanically interact with the tripping lever. As a result, it is ensured that during a crash and whilst the two joint levers move along the crash actuation track, the locking mechanism is not unintentionally opened. The mechanical blocking on the crash actuation track corresponds to the actuating lever not reaching the tripping lever or not being able to interact with it. The locking mechanism is consequently also not unintentionally opened. The invention also covers versions in which the actuating lever directly acts on the tripping lever as well as deviating embodiments in which the actuating lever directly acts on the tripping lever for opening the locking mechanism by means of one or several elements.

The design is in any case such that during normal operation and in case of a normal actuation, the two levers jointly move along a normal actuation track. During this movement, the levers are not mechanically blocked. During a crash, the two levers jointly move along the crash actuation track deviating from the normal actuation track. The crash actuation track deviates from the normal actuation track in the manner that the ratchet lever is typically blocked. As a result, also the actuating lever is blocked and before it can directly or indirectly interact with the tripping lever for opening the locking mechanism. In this way, unwanted opening of the locking mechanism is suppressed, as described.

The mechanical blocking of the combined levers or of the ratchet lever is normally provided by a stop fixed to the housing. This stop can be arranged at the edge of the frame box or can even be integrated in it. This supports the compact design of the inventive motor vehicle door latch, as exposed and separately arranged stops are expressly not required and as the stop is or can, instead, be structurally integrated in the frame box.

According to an advantageous embodiment, the ratchet lever is connected to the actuating lever in the manner of a toggle lever. In this way, the blocking lever and the actuating lever form a toggle lever angle between them. Normal operation corresponds to a specified toggle lever angle, whilst the crash operation is associated with a greater (or also smaller) toggle lever angle. This means that the crash operation is characterized by a toggle lever angle differing from the toggle lever angle of the normal operation. The deviation of the toggle lever angle between the two levers, flexibly connected to each other, automatically causes the assembly consisting of the two levers or the two levers together to form a crash actuation track and causes and allows the ratchet lever to move against said stop.

In detail, the design is in most cases such that the normal actuation track is associated with a circular movement of an outer edge of the blocking lever in comparison to the axis with a predefined radius. In contrast, the crash actuating route corresponds to a circular movement of the outer edge of the ratchet levers with a comparative larger (or smaller) and in any case, different radius.

In other words, the outer edge of the ratchet lever first of all forms a circular arc with the axis as its centre point. The axis is generally a rotary axis, defined by a bearing bolt accommodating the actuating lever. This means that the actuating lever is pivotably mounted on the respective bearing bolt with the bearing bolt in turn being anchored in the frame box.

The said axis defined as such also acts as an axis or rotary axis for the ratchet lever pivotable in relation to it. In this arrangement, the actuating lever and the ratchet lever flexibly connected thereto together form said circular arc or carry out a circular arc movement in relation to the axis or rotary axis. Depending on whether a normal operation or a crash operation exists, the circular arc or the respective circular arc movement has a different radius. In most cases the design is such that the normal actuation track corresponds to a circular arc movement of a specified radius, whilst the crash actuation travel forms a circular arc with a comparatively greater radius.

Generally, the crash actuation track can, however, also feature a smaller radius in comparison to the normal actuation track.

In any case, this deviation in the radial distance of the outer edge of the ratchet lever in relation to the axis during the transition from normal operation to the crash operation causes the external edge of the ratchet lever to interact with the said stop in such a way that the ratchet lever and thus the actuating lever are blocked.

Of special significance for the invention is the further circumstance that during normal operation, the two levers carry out a forced movement in the joint coupling said levers. This means that the normal operation corresponds to the two levers causing a compulsory change of the toggle lever angle between each other. Said forced movement corresponds to this. As a result, sticking, corrosion, etc. in the respective coupling joint is prevented from the outset, as during normal operation, the toggle lever is varied between the actuating lever and the ratchet lever i.e. during each actuation of the actuating lever for opening the locking mechanism.

In order to achieve this in detail, a guiding groove is generally provided for the forced movement of the two levers. The ratchet lever interacts with said guiding groove at least at the end of the normal actuation track. Generally, the design is such that the blocking lever moves against said guiding groove at the end of the normal actuation track and with the tripping lever being acted upon and pivots away from the actuating lever. As a result, the toggle lever angle formed between the two levers and the joint is activated in order to ensure its permanent reliable functioning. In principle, the toggle lever angle can also be decreased.

The two levers can be resiliently coupled by means of a spring. Generally, the spring ensures that together with a stop, the two levers are held at a toggle lever angle to each other that corresponds to a normal operation and in an elastically flexible manner. Starting from this toggle lever angle associated with the normal operation, the angle can naturally be changed. According to the invention, the respective toggle lever angle is increased as part of the described forced movement at the end of the normal actuation track and is also similarly increased in the event of a crash.

In most cases, one leg is an actuating lever leg and the other leg a ratchet lever leg. The actuating lever leg rests against an actuating lever or is connected to it. In contrast, the ratchet lever leg enters into a mechanical connection with the ratchet lever. An additional eyelet or leg eye of the leg spring connecting the two legs is captured by a bearing bolt, providing the flexible bearing between the ratchet lever and the actuating lever.

The result is a motor vehicle door latch offering the advantage of a particularly compact and reliable design. The compact design is mainly made possible as the ratchet lever is explicitly flexibly connected to the actuating lever, acting on the tripping lever. In this way, both levers define a toggle lever arrangement. The toggle lever angle between the two levers can change.

The normal operation actually corresponds to a certain toggle lever angle, which in the event of a crash is enlarged in the example as a result of the applied retarding forces. Due to the fact that the two levers spread apart in the event of a crash and that the toggle lever angle is enlarged in the example, the outer edge of the ratchet lever reaches the stop when following the crash actuation track, said stop being preferably arranged or formed on the frame box. As a result, both levers are blocked and the actuating lever cannot act on the tripping lever for opening the locking mechanism.

A similar enlargement of the toggle lever angle also occurs every time the normal actuation track has been completed. This corresponds to a forced movement of the levers to each other and in such a way that the toggle lever angle is enlarged again. This means that during normal operation, the ratchet lever carries out a similar movement as in the event of a crash. This ensures a particular reliability over the entire life of the motor vehicle door latch of the invention. These are the main advantages.

Below, the invention is explained in detail with reference to a drawing showing only one embodiment in which:

### BRIEF DESCRIPTION OF THE DRAWINGS

FIG. 1 shows a perspective view of sections of the motor vehicle door latch of the invention and

FIG. 2A to 2C show the motor vehicle door latch of FIG. 1 in its resting position (FIG. 2A), during normal operation (FIG. 2B) and finally in the event of a crash actuation (FIG. 2C).

### DETAILED DESCRIPTION OF THE DRAWINGS

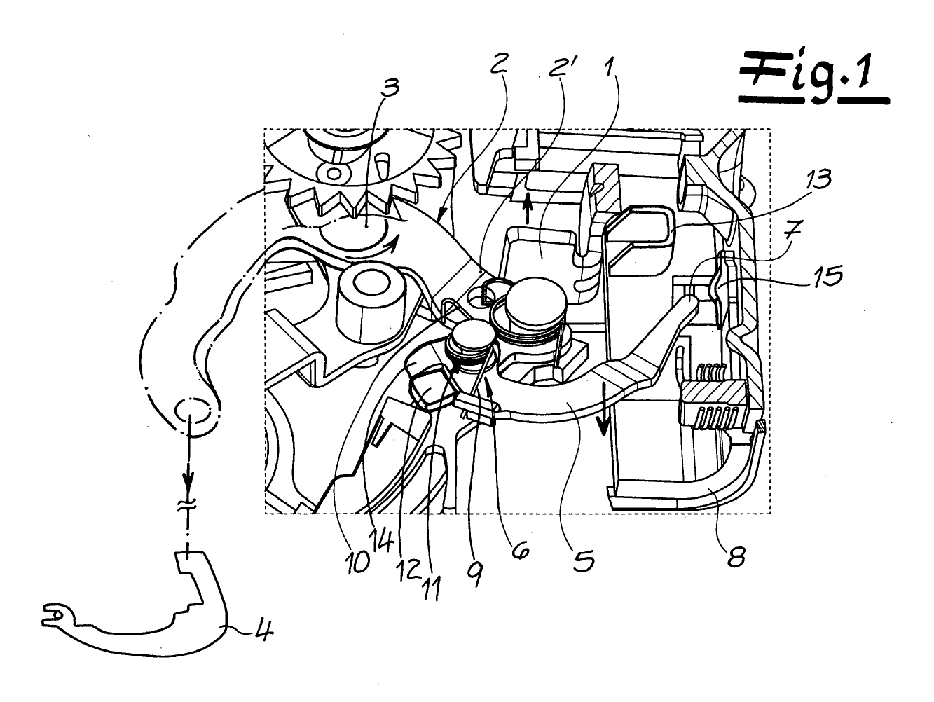

The figures show a motor vehicle door latch, which is equipped with a locking mechanism not indicated and shown in detail and that comprises a catch and a pawl. The locking mechanism is acted upon by a tripping lever 1, whose movement in a direction indicated by the arrow in FIG. 1, causes the pawl to be lifted off the catch in the known manner. As a result, the catch can open with the aid of a spring, releasing a previously retained closing pin. At the same time, a motor vehicle door can be opened or is opened. This corresponds to the so-called normal operation.

In order to act on the tripping lever 1 in the direction of the arrows in FIG. 1 for opening the locking mechanism, the example embodiment provides for an actuating lever 2. The actuating lever 2 is part of the actuating lever mechanism not specified in more detail.

The actuating lever 2 can be pivoted around its axis 3 in counterclockwise direction indicated in FIG. 1 so that a lever arm 2′ of the actuating lever 2 moves against the tripping lever 1, acting upon it in the direction of the arrow in order to open the locking mechanism.

In order to pivot the actuating lever 2 counterclockwise around its axis 3, the actuating lever 2 is regularly and as shown in the example, connected to an external door handle 4, only indicated in FIG. 1. The actuating lever 2 in the example is thus an external actuating lever 2, although the invention is not restricted to this.

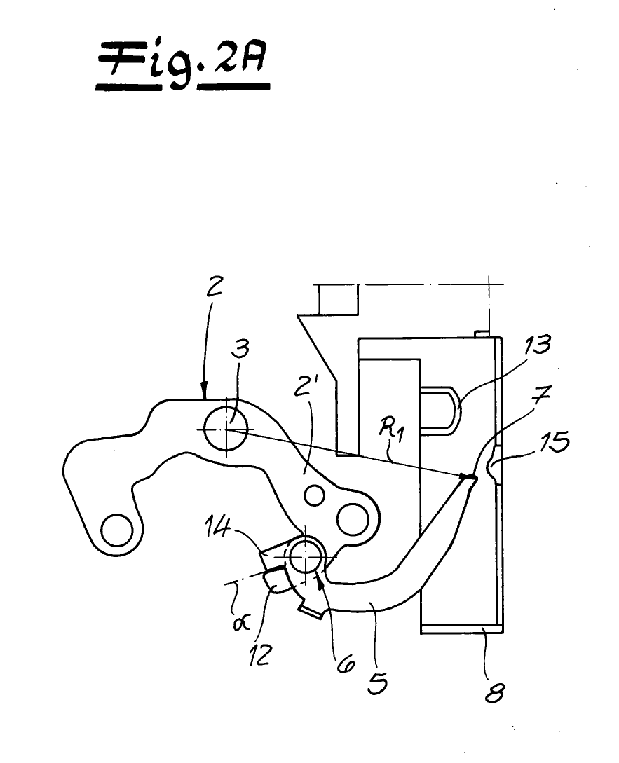

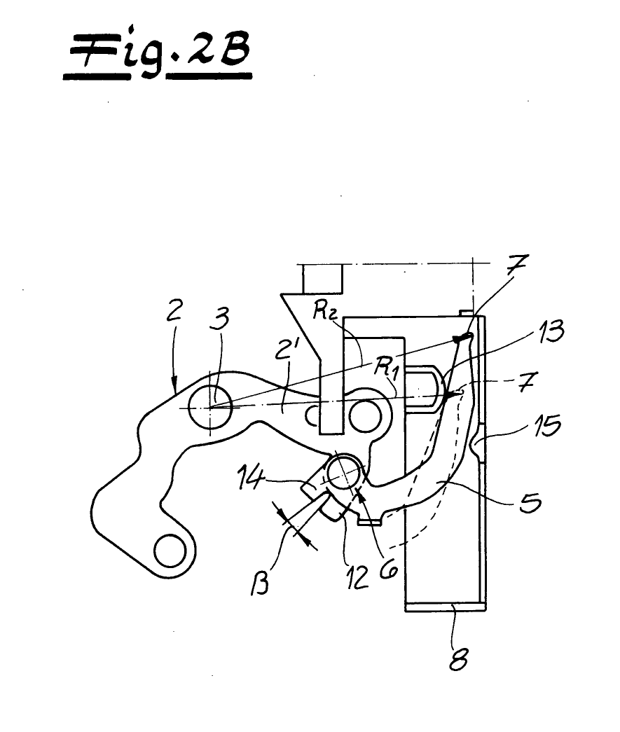

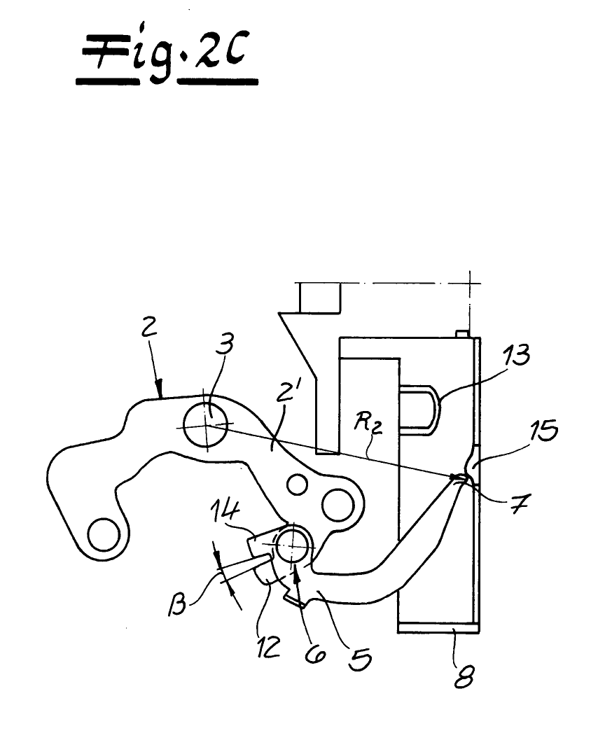

The further basic arrangement includes a ratchet lever 5, which according to the invention is connected to the actuating lever or external actuating lever 2 by means of a joint 6. In the event of retarding forces of a given magnitude and direction occurring, such in case of a crash, the ratchet lever is acted upon in the direction indicated by an arrow in FIGS. 1 and 2C. As a result, the ratchet lever 5 and also the actuating lever 2, are blocked so that the actuating lever 2 cannot act on the tripping lever 1 for opening the locking mechanism, as explained in detail below.

As already described, the ratchet lever 5 is flexibly connected to the actuating lever 2 by means of the joint 6. The actuating lever can, in turn, act on the tripping lever 1. Both levers 2, 5′ together define a toggle lever arrangement 2, 5 with the interposed joint 6, thus functioning as a toggle joint 6.

Looking at the resting position in FIG. 2A and the normal operation as shown in FIG. 2B, it is apparent that both levers 2, 5 together follow a normal actuation track R₁ during normal operation. The levers follow the normal actuation track R₁ without the two levers 2, 5 being blocked. Effectively, the normal actuation track R₁ corresponds to a circular arc movement of an outer edge or outer tip 7 of the ratchet lever 5 in comparison to axis 3, functioning to this effect as a centre point for the circular arc. Effectively, the two levers 2, 5 together are mounted on a bearing pin or bearing bolt secured in a frame box 8 and defining an axis or rotary axis 3. During normal operation or when following the normal actuation track R1, the outer edge 7 of the ratchet lever 5 in relation to said axis 3 carries out said circular arc movement with radius R1 in comparison to the centre point defining axis 3.

From the transition between FIG. 2A and FIG. 2B, it is apparent that starting from the resting position in FIG. 2A up to the end position or taking into consideration the total travel according to FIG. 2B, the two levers 2, 5 or the associated toggle lever arrangement 2, 5 is not mechanically blocked. Consequently, the actuating lever 2 can act on the tripping lever 1 with its arm 2′ during normal operation and in the direction shown in FIG. 1 so that the locking mechanism is opened as a result thereof. At the same time the two levers 2, 5 are subjected to a forced movement during normal operation in relation to the joint 6 coupling the levers. This forced movement is apparent when comparing FIG. 2A and 2B.

Effectively, the two levers 2, 5 are coupled by means of a spring 9, 10, 11. The spring 9, 10, 11 is a leg spring 9, 10, 11. The leg spring 9, 10, 11 contains a ratchet lever leg 9 connected to the ratchet lever 5. The leg spring 9, 10, 11 also contains an actuating lever leg 10, connected to the actuating lever 2 or interacting with it. The figure also shows a leg eye 11, surrounding a bearing pin defining the joint or toggle joint 6.

In addition to this spring or leg spring 9, 10, 11 one stop 12 or two stops 12, 14 are provided. In the example embodiment, the stop 12 is an extension of the actuating lever 2. The stop 14 in contrast is an extension of the ratchet lever 5. Together with the stop 12 or the two stops 12, 14, the spring 9, 10, 11 holds the two levers 2, 5 at an associated toggle lever angle α indicated in FIG. 2A. During normal operation, the two levers 2, 5 carry out a forced movement in the coupling joint 6. A guiding groove 13 arranged in the housing or frame box 8 is responsible for the forced movement. Effectively the ratchet lever 5 interacts at least at one end of the normal actuation track R₁ with said guiding groove 13. This is apparent from the transition between FIG. 2A and FIG. 2B.

When reaching the end of the normal actuation track and when the tripping lever 1 has already been acted upon, the ratchet lever 5 moves against said guiding groove 13 in order to open the locking mechanism. The further movement of the ratchet lever 5 during normal operation, i. e. in case of a counterclockwise movement of the two levers 2, 5 together around their common axis 3, causes the ratchet lever 5 to pivot away from the actuating lever 2. At the same time, the respective toggle lever angle α increases and corresponds to a toggle lever angle β with α<β. This is possible as in this context the spring 9, 10, 11 coupling the two levers 2, 5 yields elastically and as the stop 14 on the ratchet lever 5 is released from the stop 12 on the actuating lever 2. This is apparent in FIG. 2B, showing a gap between the two stops 12, 14. At the same time as the toggle lever angle α is increased to the toggle lever angle β, the joint 6 is activated so that any sticking, corrosion, etc. can as such not occur.

When in contrast to the normal operation, a crash occurs, the outer edge 7 of the ratchet lever 5 or the two levers 2, 5 together follow a crash actuation track R₂ deviating from aforementioned normal actuation track R₁, as shown in FIG. 2C. Effectively, the crash actuation track R₂ also causes a circular arc movement, carried out by the external edge 7 of the ratchet lever 5 in relation to axis 3, representing the centre point. In contrast to the normal actuation track R₁, the crash actuation track R₂ contains a greater radius R₂. This means that the following applies:

R₂>R₁.

The enlargement of radius R₂ is caused by the fact that in the event of a crash, the ratchet lever 5 is pivoted away from the actuating lever 2 as a result of the retarding forces indicated by an arrow in FIG. 1 and FIG. 2C. At the same time, also the toggle lever angle α is increased from a to values around 13, as already seen at the end of the normal operation in relation to FIG. 2B. This means that during the crash, the movement of the toggle lever arrangement 2, 5 is similar to that of the normal operation at the end of the actuation stroke. This ensures an extremely high level of reliability.

Due to the enlarged radius R₂ of the circular arc or respective crash actuation track R₂ completed by the outer edge 7 of the ratchet levers 5, the toggle lever arrangement 2, 5 or the levers 2, 5 together can not (no longer) act on the tripping lever 1. This is due to the fact that the external edge 7 of the ratchet lever 5 moves against a stop 15 formed on the frame box 8 or that is connected to the frame box 8.

In other words, during a crash the levers 2, 5 are spread as regards their toggle lever a so that the toggle lever is increased from α to β. This spreading of the two levers 2, 5 causes the outer edge 7 of the ratchet lever 5—due to the applied retarding forces—to move “outwardly” in relation to the frame box 8, causing the external edge 7 to move against the stop 15 provided at the outer edge of the frame box 8. This occurs even before the actuating lever 2 can interact with the tripping lever 1. Consequently the locking mechanism is not influenced and cannot be opened unintentionally.

1. Motor vehicle door latch which is equipped with a locking mechanism, a tripping lever for opening the locking mechanism and a ratchet lever that is pivotable around an axis, rendering the locking mechanism ineffective at least with regard to the magnitude and direction of occurring retarding forces, for example in an accident (“crash”), characterized in that the ratchet lever is connected to an actuating lever applying force on a the tripping lever in such an articulated manner that both levers together in normal operation describe a predetermined normal actuation track without mechanical blocking and in the crash operation describe a crash actuation track deviating from the normal actuation track while simultaneously a mechanical blocking occurs.

2. Motor vehicle door latch according to claim 1, characterized in that the ratchet lever is connected to the actuating lever in form of a toggle lever, forming a toggle lever arrangement, with the normal operation corresponding to a predetermined toggle lever angle (α) and the crash operation to a comparatively greater (smaller) toggle lever angle (β).

3. Motor vehicle door latch according to claim 1, characterized in that the normal actuation track is associated with a circular arc movement of an outer edge of the ratchet lever in comparison to the axis with a predetermined radius.

4. Motor vehicle door latch according to claim 1, characterized in that the crash actuation track corresponds to a circular arc movement of an external edge of the ratchet lever with a respective greater (smaller) radius.

5. Motor vehicle door latch according to claim 1, characterized in that in normal operation, the two levers carry out a forced movement in a joint coupling said levers.

6. Motor vehicle door latch according to claim 5, characterized in that a guiding grove is provided for the forced movement of the two levers, with which the ratchet lever interacts at least at an end of the normal actuation track.

7. Motor vehicle door latch according to claim 5, characterized in that the ratchet lever at an end of the normal actuation track and with a force applied on the tripping lever moves against the guiding groove and pivots away from the actuating lever.

8. Motor vehicle door latch according to claim 1, characterized in that the two levers are coupled by a spring.

9. Motor vehicle door latch according to claim 8, characterized in that the spring together with at least one stop resiliently holds the levers at the toggle lever angle (α) associated with normal operation.

10. Motor vehicle door latch according to claim 8, characterized in that the spring is designed as a leg spring with an actuating lever leg and a ratchet lever leg.

11. Motor vehicle door latch according to claim 9, characterized in that the spring is designed as a leg spring with an actuating lever leg and a ratchet lever leg.

12. Motor vehicle door latch according to claim 2, characterized in that the normal actuation track is associated with a circular arc movement of an outer edge of the ratchet lever in comparison to the axis with a predetermined radius.

13. Motor vehicle door latch according to claim 12, characterized in that the crash actuation track corresponds to a circular arc movement of an external edge of the ratchet lever with a respective greater (smaller) radius.

14. Motor vehicle door latch according to claim 13, characterized in that in normal operation, the two levers carry out a forced movement in a joint coupling said levers.

15. Motor vehicle door latch according to claim 14, characterized in that a guiding grove is provided for the forced movement of the two levers, with which the ratchet lever interacts at least at an end of the normal actuation track.

16. Motor vehicle door latch according to claim 15, characterized in that the ratchet lever at the end of the normal actuation track and with a force applied on the tripping lever moves against the guiding groove and pivots away from the actuating lever.

17. Motor vehicle door latch according to claim 16, characterized in that the two levers are coupled by a spring.

18. Motor vehicle door latch according to claim 17, characterized in that the spring together with at least one stop resiliently holds the levers at the toggle lever angle (α) associated with normal operation.

19. Motor vehicle door latch according to claim 18, characterized in that the spring is designed as a leg spring with an actuating lever leg and a ratchet lever leg.
